(19) United States
(12) Patent Application Publication
(10) Pub. No.: US 2024/0049796 A1
(43) Pub. Date: Feb. 15, 2024

(54) AEROSOL GENERATING SYSTEM

(71) Applicant: NICOVENTURES TRADING LIMITED, London (GB)

(72) Inventor: Patrick MOLONEY, London (GB)

(21) Appl. No.: 18/257,783

(22) PCT Filed: Dec. 22, 2021
(86) PCT No.: PCT/EP2021/087392

§ 371 Date: Jun. 15, 2023

(30) Foreign Application Priority Data
Dec. 22, 2020 (GB) 2020394.9

(51) Int. Cl. A24F 40/465; H05B 6/10; A24F 40/20; A24F 40/10; A24D 1/20

(52) U.S. Cl. CPC A24F 40/465; H05B 6/105; A24F 40/20; A24F 40/10; A24D 1/20

(57) ABSTRACT

An aerosol generating system is disclosed and can include an aerosol generating device having one or more inductor coils and one or more susceptors wherein, in use, an article for use with a non-combustible aerosol provision device comprising a non-magnetic metallic component is positioned in proximity to one or more of the susceptors.

### PRIORITY CLAIM

The present application is a National Phase entry of PCT Application No. PCT/EP2021/087392, filed Dec. 22, 2021, which claims priority from GB Application No. 2020394.9, filed Dec. 22, 2020, each of which is hereby fully incorporated herein by reference.

### TECHNICAL FIELD

The present disclosure relates to heating assemblies for use with apparatus for heating aerosolizable material to volatilize at least one component of the aerosolizable material, apparatuses for heating aerosolizable material to volatilize at least one component of the aerosolizable material, and systems comprising a heating assembly and an apparatus for heating aerosolizable material to volatilize at least one component of the aerosolizable material.

### BACKGROUND

Smoking articles such as cigarettes, cigars and the like burn tobacco during use to create tobacco smoke. Attempts have been made to provide alternatives to these articles by creating products that release compounds without combusting. Examples of such products are so-called “heat not burn” products or tobacco heating devices or products, which release compounds by heating, but not burning, material. The material may be, for example, tobacco or other non-tobacco products, which may or may not contain nicotine.

Aerosol provision systems, which cover the aforementioned devices or products, are known. Common systems use heaters to create an aerosol from a suitable medium which is then inhaled by a user. Often the medium used needs to be replaced or changed to provide a different aerosol for inhalation. It is known to use induction heating systems as heaters to create an aerosol from a suitable medium. An induction heating system generally consists of a magnetic field generating device for generating a varying magnetic field, and a susceptor which is heatable by penetration with the varying magnetic field to heat the suitable medium.

Many different magnetic field generating devices are known, such as a three dimensional inductor coil. However, there are a variety of constraints, such as the available space, size of device, and power requirements, which places a restriction on the types of magnetic field generating devices. Furthermore, there are a variety of parameters which limit the efficiency of the inductive coupling between the magnetic field generating device and the susceptor. For example, such parameters include the separation between the magnetic field generating device and the susceptor, or the relative area sizes and orientations thereof.

It is desired to provide an improved aerosol generating system.

### SUMMARY

According to an aspect there is provided an aerosol generating system comprising an aerosol generating device having one or more inductor coils and one or more susceptors wherein, in use, an article for use with a non-combustible aerosol provision device comprising a non-magnetic metallic component is positioned in proximity to one or more of the susceptors.

The one or more susceptors may comprise one or more ferritic elements which may comprise a ceramic material.

According to an embodiment the one or more ferritic elements may be formed by mixing iron (III) oxide (Fe₂O₃) with one or more additional metallic elements to form a mixture and then heating the mixture to form a ceramic.

According to an embodiment the one or more additional metallic elements may be selected from the group comprising: (i) barium; (ii) manganese; (iii) nickel; and (iv) zinc.

According to an embodiment the one or more ferritic elements may be electrically non-conductive. The one or more ferritic elements may comprise an electrical insulator.

According to an embodiment the one or more ferritic elements may be either: (i) magnetizable; (ii) ferromagnetic; or (iii) ferrimagnetic.

According to an embodiment the one or more inductor coils may be arranged to generate a varying magnetic field and wherein the one or more susceptors may be arranged to become heated by the varying magnetic field.

According to an embodiment the one or more susceptors may be arranged and adapted to heat not burn aerosolizable material provided in an article for use with a non-combustible aerosol provision device.

According to an embodiment the one or more susceptors may be arranged and adapted to generate aerosol from aerosolizable material provided in an article for use with a non-combustible aerosol provision device.

According to an embodiment the aerosol generating device comprises a heat not burn aerosol generating device. According to an embodiment the aerosol generating device comprises a non-combustible aerosol provision device.

According to an aspect there is provided an aerosol generating system comprising an aerosol generating system as described above in combination with an article for use with a non-combustible aerosol provision device.

According to an embodiment the article for use with a non-combustible aerosol provision device may include one or more aluminum elements.

According to an embodiment the article for use with a non-combustible aerosol provision device may be inserted into the aerosol generating device so that at least a portion of one of the aluminum elements is located in close proximity to at least a portion of one of the ferritic elements.

According to an embodiment the article for use with a non-combustible aerosol provision device may be inserted into the aerosol generating device so that at least a portion of one of the aluminum elements is located less than 10 mm, 9 mm, 8 mm, 7 mm, 6 mm, 5 mm, 4 mm, 3 mm, 2 mm or 1 mm from at least a portion of one of the ferritic elements.

According to an embodiment the article for use with a non-combustible aerosol provision device may comprise aerosolizable material.

According to an embodiment the aerosolizable material may be provided: (i) as a solid; (ii) as a liquid; (iii) in the form of a gel; (iv) in the form of a thin film substrate; (v) in the form of a thin film substrate having multiple regions; or (vi) in the form of a thin film substrate having multiple regions, wherein at least two of the regions comprise aerosolizable material having different compositions.

According to an aspect there is provided a method of generating an aerosol comprising:
providing an aerosol generating device having one or more inductor coils and one or more susceptors; and
inserting an article for use with a non-combustible aerosol provision device comprising a non-magnetic metallic component in proximity to one or more of the susceptors.

According to an embodiment the article for use with a non-combustible aerosol provision device may include one or more aluminum elements.

According to an embodiment the article for use with a non-combustible aerosol provision device may be inserted into the aerosol generating device so that at least a portion of one of the aluminum elements is located in close proximity to at least a portion of one of the ferritic elements.

According to an embodiment the article for use with a non-combustible aerosol provision device may be inserted into the aerosol generating device so that at least a portion of one of the aluminum elements is located less than 10 mm, 9 mm, 8 mm, 7 mm, 6 mm, 5 mm, 4 mm, 3 mm, 2 mm or 1 mm from at least a portion of one of the ferritic elements.

According to an aspect there is provided an aerosol generating system comprising:
an aerosol generating device comprising one or more ferritic susceptors; and
an article for use with a non-combustible aerosol provision device having one or more non-magnetic metallic elements.

According to an embodiment the one or more non-magnetic metallic elements may comprise aluminum.

According to an embodiment the one or more non-magnetic metallic elements may be arranged so as to be positioned in thermal contact with the one or more ferritic susceptors.

According to an embodiment the article for use with a non-combustible aerosol provision device may be arranged to be inserted into the aerosol generating device so that at least a portion of one of the non-magnetic metallic elements is located less than 10 mm, 9 mm, 8 mm, 7 mm, 6 mm, 5 mm, 4 mm, 3 mm, 2 mm or 1 mm from at least a portion of one of the ferritic susceptors.

According to an aspect there is provided an aerosol generating system comprising:
an aerosol generating device comprising one or more inductor coils;
an article for use with a non-combustible aerosol provision device located, in use, within the aerosol generating device; and
one or more removable susceptors located, in use, within the aerosol generating device.

According to an embodiment the one or more removable susceptors may comprise one or more ferritic elements.

According to an embodiment the one or more ferritic elements may comprise a ceramic material.

According to an embodiment the one or more ferritic elements may be formed by mixing iron (III) oxide (Fe₂O₃) with one or more additional metallic elements to form a mixture and then heating the mixture to form a ceramic.

According to an embodiment the one or more additional metallic elements may be selected from the group comprising: (i) barium; (ii) manganese; (iii) nickel; and (iv) zinc.

According to an embodiment the terrific element may be electrically non-conductive.

According to an embodiment the terrific element may comprise an electrical insulator.

According to an embodiment the terrific element may be either: (i) magnetizable; (ii) ferromagnetic; or (iii) ferrimagnetic.

According to an embodiment the one or more inductor coils may be arranged to generate a varying magnetic field and wherein the one or more susceptors may be arranged to become heated by the varying magnetic field.

According to an embodiment the one or more susceptors may be arranged and adapted to heat not burn aerosolizable material provided in the article for use with a non-combustible aerosol provision device The one or more susceptors may be arranged and adapted to generate aerosol from aerosolizable material provided in the article for use with a non-combustible aerosol provision device.

According to an embodiment the aerosol generating device may comprise a heat not burn aerosol generating device. The aerosol generating device may comprise a non-combustible aerosol provision device.

According to an embodiment the article for use with a non-combustible aerosol provision device may include one or more aluminum elements.

According to an embodiment the article for use with a non-combustible aerosol provision device may be inserted into the aerosol generating device so that at least a portion of one of the aluminum elements is located in close proximity to at least a portion of one of the ferritic elements.

According to an embodiment the article for use with a non-combustible aerosol provision device may be inserted into the aerosol generating device so that at least a portion of one of the aluminum elements is located less than 10 mm, 9 mm, 8 mm, 7 mm, 6 mm, 5 mm, 4 mm, 3 mm, 2 mm or 1 mm from at least a portion of one of the ferritic elements.

According to an embodiment the article for use with a non-combustible aerosol provision device may comprise aerosolizable material. The aerosolizable material may be provided: (i) as a solid; (ii) as a liquid; (iii) in the form of a gel; (iv) in the form of a thin film substrate; (v) in the form of a thin film substrate having multiple regions; or (vi) in the form of a thin film substrate having multiple regions, wherein at least two of the regions comprise aerosolizable material having different compositions.

According to another aspect there is provided an aerosol generating device comprising one or more inductor coils, wherein the device is arranged and adapted: (i) to receive an article for use with a non-combustible aerosol provision device which is located, in use, within the aerosol generating device; and (ii) to receive one or more removable susceptors which are located, in use, within the aerosol generating device.

According to an aspect there is provided a method of generating an aerosol comprising:
providing an aerosol generating device comprising one or more inductor coils;
locating an article for use with a non-combustible aerosol provision device within the aerosol generating device; and
locating one or more removable susceptors within the aerosol generating device.

According to an aspect there is provided an aerosol generating system comprising: an aerosol generating device; and an article for use with a non-combustible aerosol provision device located, in use, within the aerosol generating device, wherein the article for use with a non-combustible aerosol provision device may comprise one or more inductor coils and/or one or more susceptors.

According to an embodiment the one or more susceptors may comprise one or more ferritic elements. The one or more terrific elements may comprise a ceramic material.

According to an embodiment the one or more ferritic elements may be formed by mixing iron (III) oxide (Fe₂O₃) with one or more additional metallic elements to form a mixture and then heating the mixture to form a ceramic.

According to an embodiment the one or more additional metallic elements may be selected from the group comprising: (i) barium; (ii) manganese; (iii) nickel; and (iv) zinc.

According to an embodiment the one or more ferritic elements may be electrically non-conductive. The one or more ferritic elements may be an electrical insulator.

According to an embodiment the one or more ferritic elements may be either: (i) magnetizable; (ii) ferromagnetic; or (iii) ferrimagnetic.

According to an embodiment the one or more inductor coils may be arranged to generate a varying magnetic field and wherein the one or more susceptors may be arranged to become heated by the varying magnetic field.

According to an embodiment the one or more susceptors may be arranged and adapted to heat not burn aerosolizable material provided in the article for use with a non-combustible aerosol provision device The one or more susceptors may be arranged and adapted to generate aerosol from aerosolizable material provided in the article for use with a non-combustible aerosol provision device

According to an embodiment the aerosol generating device may comprise a heat not burn aerosol generating device. The aerosol generating device may comprise a non-combustible aerosol provision device.

According to an embodiment the article for use with a non-combustible aerosol provision device may include one or more aluminum elements.

According to an embodiment the article for use with a non-combustible aerosol provision device may be inserted into the aerosol generating device so that at least a portion of one of the aluminum elements is located in close proximity to at least a portion of one of the ferritic elements.

According to an embodiment the article for use with a non-combustible aerosol provision device may be inserted into the aerosol generating device so that at least a portion of one of the aluminum elements is located less than 10 mm, 9 mm, 8 mm, 7 mm, 6 mm, 5 mm, 4 mm, 3 mm, 2 mm or 1 mm from at least a portion of one of the ferritic elements.

According to an embodiment the article for use with a non-combustible aerosol provision device may comprise aerosolizable material. The aerosolizable material may be provided: (i) as a solid; (ii) as a liquid; (iii) in the form of a gel; (iv) in the form of a thin film substrate; (v) in the form of a thin film substrate having multiple regions; or (vi) in the form of a thin film substrate having multiple regions, wherein at least two of the regions comprise aerosolizable material having different compositions.

According to an aspect there is provided a method of generating an aerosol comprising:
providing an aerosol generating device; and
inserting an article for use with a non-combustible aerosol provision device into the aerosol generating device wherein the article for use with a non-combustible aerosol provision device may comprise one or more inductor coils and/or one or more susceptors.

According to an embodiment the article for use with a non-combustible aerosol provision device may include one or more aluminum elements.

According to an embodiment the article for use with a non-combustible aerosol provision device may be inserted into the aerosol generating device so that at least a portion of one of the aluminum elements is located in close proximity to at least a portion of one of the ferritic elements.

According to an embodiment the article for use with a non-combustible aerosol provision device may be inserted into the aerosol generating device so that at least a portion of one of the aluminum elements is located less than 10 mm, 9 mm, 8 mm, 7 mm, 6 mm, 5 mm, 4 mm, 3 mm, 2 mm or 1 mm from at least a portion of one of the ferritic elements.

According to an aspect there is provided a method of fabricating an aerosol generating device comprising:
forming one or more inductor coils and one or more susceptors within the device, wherein at least one of the susceptors may comprise one or more ferritic elements.

According to an aspect there is provided a method of fabricating a susceptor comprising: forming one or more removable susceptors which are located, in use, within an aerosol generating device and which may be readily removed from the aerosol generating device.

According to an aspect there is provided a method of fabricating an article for use with a non-combustible aerosol provision device comprising:
forming an article for use with a non-combustible aerosol provision device which is located, in use, within an aerosol generating device, wherein the article for use with a non-combustible aerosol provision device may comprise one or more inductor coils and/or one or more susceptors.

### BRIEF DESCRIPTION OF THE DRAWINGS

Various embodiments of the present disclosure will now be described, by way of example only, with reference to the accompanying drawings, in which:

FIG. 1 shows a schematic cross-sectional side view of an example heating assembly for use with apparatus for heating aerosolizable material to volatilize at least one component of the aerosolizable material;

FIG. 2 shows the example heating assembly of FIG. 1 and an example of an article comprising aerosolizable material insertable into the heating assembly;

FIG. 3 shows a schematic cross-sectional side view of an example of a system for heating aerosolizable material to volatilize at least one component of the aerosolizable material and an example of an article comprising aerosolizable material insertable into the heating assembly of the system;

FIG. 4 shows a schematic cross-sectional side view of the example system of FIG. 3;

FIG. 5 shows a schematic cross-sectional side view of another example system for heating aerosolizable material to volatilize at least one component of the aerosolizable material; and

FIG. 6A shows a cross-sectional view of a heating assembly within an aerosol-generating device according to an embodiment and FIG. 6B shows a close-up view of a portion of the heating assembly of FIG. 6A according to an embodiment.

### DETAILED DESCRIPTION

As used herein, the term “aerosolizable material”, also referred to as aerosol generating material, includes materials that provide volatilized components upon heating, typically in the form of vapor or an aerosol. “Aerosolizable material” may be a non-tobacco-containing material or a tobacco-containing material. “Aerosolizable material” may, for example, include one or more of tobacco per se, tobacco derivatives, expanded tobacco, reconstituted tobacco, tobacco extract, homogenized tobacco or tobacco substitutes. The aerosolizable material can be in the form of ground tobacco, cut rag tobacco, extruded tobacco, reconstituted tobacco, reconstituted aerosolizable material, liquid, gel, gelled sheet, powder, or agglomerates, or the like.

“Aerosolizable material” also may include other, non-tobacco, products, which, depending on the product, may or may not contain nicotine. “Aerosolizable material” may comprise one or more humectants, such as glycerol or propylene glycol.

As used herein, the term “sheet” denotes an element having a width and length substantially greater than a thickness thereof. The sheet may be a strip, for example.

As used herein, the term “heating material” or “heater material” refers to material that is heatable by penetration with a varying magnetic field.

Induction heating is a process in which an electrically-conductive object is heated by penetrating the object with a varying magnetic field. The process is described by Faraday's law of induction and Ohm's law. An induction heater may comprise an electromagnet and a device for passing a varying electrical current, such as an alternating current, through the electromagnet. When the electromagnet and the object to be heated are suitably relatively positioned so that the resultant varying magnetic field produced by the electromagnet penetrates the object, one or more eddy currents are generated inside the object. The object has a resistance to the flow of electrical currents. Therefore, when such eddy currents are generated in the object, their flow against the electrical resistance of the object causes the object to be heated. This process is called Joule, ohmic, or resistive heating. An object that is capable of being inductively heated is known as a susceptor.

It has been found that, when the susceptor is in the form of a closed electrical circuit, magnetic coupling between the susceptor and the electromagnet in use is enhanced, which results in greater or improved Joule heating.

Magnetic hysteresis heating is a process in which an object made of a magnetic material is heated by penetrating the object with a varying magnetic field. A magnetic material can be considered to comprise many atomic-scale magnets, or magnetic dipoles. When a magnetic field penetrates such material, the magnetic dipoles align with the magnetic field. Therefore, when a varying magnetic field, such as an alternating magnetic field, for example as produced by an electromagnet, penetrates the magnetic material, the orientation of the magnetic dipoles changes with the varying applied magnetic field. Such magnetic dipole reorientation causes heat to be generated in the magnetic material.

When an object is both electrically-conductive and magnetic, penetrating the object with a varying magnetic field can cause both Joule heating and magnetic hysteresis heating in the object. Moreover, the use of magnetic material can strengthen the magnetic field, which can intensify the Joule and magnetic hysteresis heating.

In each of the above processes, as heat is generated inside the object itself, rather than by an external heat source by heat conduction, a rapid temperature rise in the object and more uniform heat distribution can be achieved, particularly through selection of suitable object material and geometry, and suitable varying magnetic field magnitude and orientation relative to the object. Moreover, as induction heating and magnetic hysteresis heating do not require a physical connection to be provided between the source of the varying magnetic field and the object, design freedom and control over the heating profile may be greater, and cost may be lower.

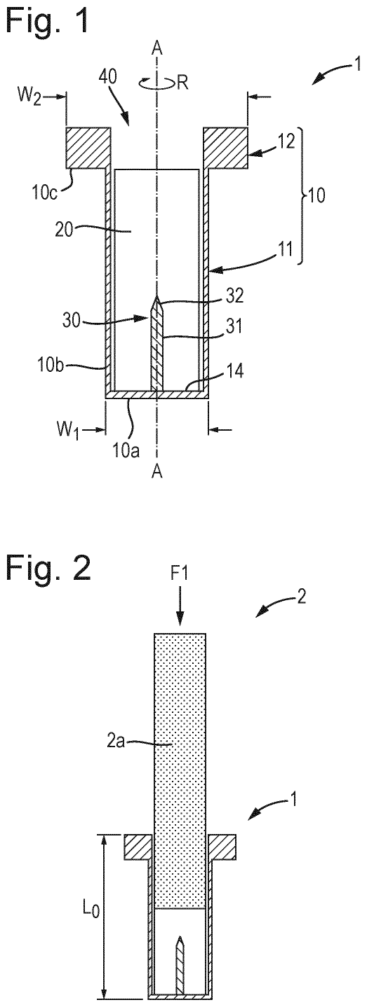

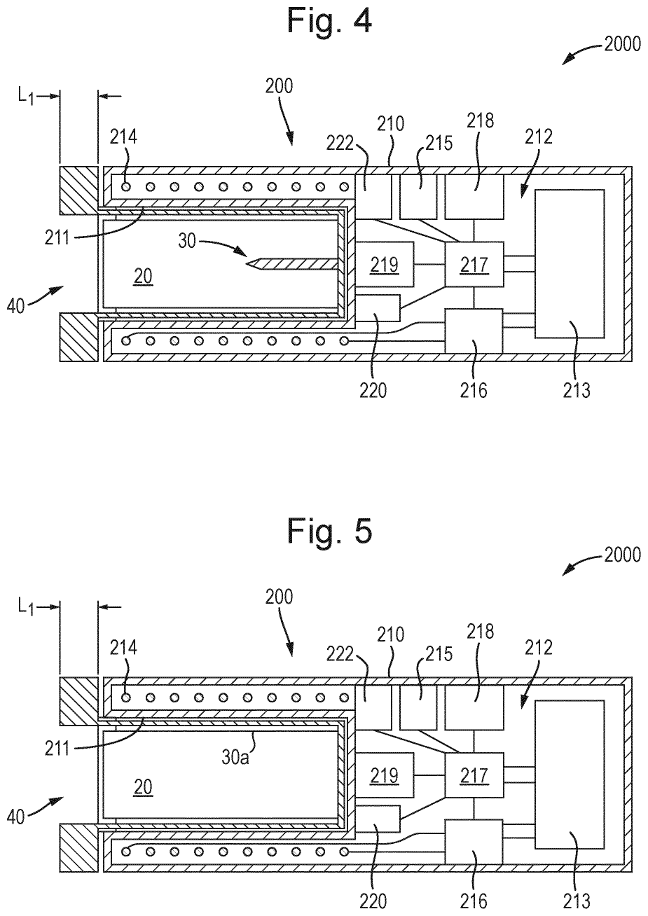

Referring to FIG. 1, there is shown a schematic cross-sectional side view of an example of a heating assembly 1 for illustrative purposes only. The heating assembly 1 is for use with apparatus for heating aerosolizable material to volatilize at least one component of the aerosolizable material, such as the apparatus 200 shown in FIG. 4 and described below. The heating assembly 1 according to the arrangement shown in FIG. 1 is configured to be removable or detachable, from the apparatus.

However, according to various embodiments the heating assembly 1 may be non-removable.

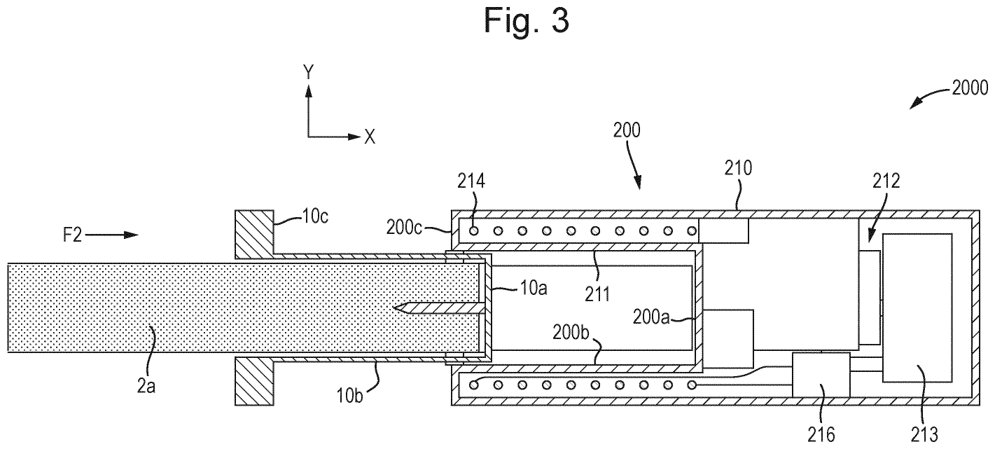

The heating assembly 1 comprises a body 10. The body 10 is formed of a first portion 11 and a second portion 12. The first portion 11 is for entry into a heating zone of the apparatus. In this embodiment, the second portion 12 is not insertable in the heating zone of the apparatus. This is because the second portion 12 is positioned at a greater distance along a longitudinal axis A-A from an end of the first portion 11 than a length of the heating zone of the apparatus (wherein said end of the first portion 11 is a point furthest from the second portion 12). Additionally, the second portion 12 has a width that is greater than a width of the heating zone of the apparatus (see FIG. 3). Therefore, the second portion 12 is incapable of being inserted into the heating zone. In other embodiments, the width of the second portion 12 is less than or equal to the width of the heating zone. In such embodiments, the width of the second portion 12 may be less than or equal to a width of the first portion 11. The heating assembly 1 comprises an abutment that limits the entry distance of the heating assembly 1 in the heating zone. In some embodiments, the heating assembly 1 does not comprise such an abutment. In the example shown, the abutment is a surface of the body 10, for example a first surface 10a, a second surface 10b and/or a third surface 10c. Each or all of the first to third surfaces 10a-c may act as a coupler of the heating assembly for coupling the heating assembly to a respective retainer of the apparatus. A coupler shown in FIG. 1 is for coupling to a respective retainer by an interference fit. An example of a such a retainer is shown in and discussed in relation to FIG. 3. In this embodiment, the first surface 10a, second surface 10b and third surface 10c is flat. In other embodiments, at least one but not all of the first to third surfaces 10a-10c may be flat. The first surface 10 and third surface 10c are parallel to each other. The second surface 10b is perpendicular to the first surface 10 and third surface 10c. However, in other embodiments, the respective surfaces may not be parallel and/or perpendicular.

Although the coupler shown in FIG. 1 relies on an interference fit with the retainer of the apparatus, a frictional fit may be sufficient in some embodiments. When an interference fit is used, the width W₁ of the first portion 11 may be greater than a corresponding width of the heating zone of the apparatus. Therefore, the second surface 10b may be configured to compress inwardly and towards the longitudinal axis A-A as the heating assembly 1 is inserted into the heating zone of the apparatus. However, an interference fit provides greater retention of the heating assembly 1 in the apparatus. In a frictional fit example, the width W₁ of the first portion 11 may be less than or equal to the corresponding width of the heating zone of the apparatus such that the second surface 10b is configured to engage by friction with a corresponding surface in the heating zone of the apparatus but the width W₁ of the first portion 11 does not change.

In some examples, the width W₁ of the first portion 11 may vary across the length of the first portion 11 and towards the second portion 12. The first portion 11 may therefore have an external surface which decreases in width from an end of the first portion 11, which may a longitudinal extent of the heating assembly 1. In contrast, a width of an internal surface of the first portion 11 may be constant such that a wall thickness may increase towards the second portion 12. The external surface may taper such that an engagement force increases the more the heating assembly 1 is inserted into the heating zone of the apparatus. The increase of engagement force may be proportional to a distance that the heating assembly 1 is inserted into the heating zone of the apparatus.

In some examples, the coupler may comprise a threaded member to engage with a corresponding threaded member of the retainer. That is, the heating assembly 1 is engageable with the apparatus by relative rotation of the heating assembly 1 and apparatus. This can sometimes be referred to as a screw action. An example axis of a direction of rotation R is shown in FIG. 1. In this instance, the axis of rotation is the longitudinal axis A-A. When the heating assembly 1 is engageable with the apparatus by a screw action, a first surface 10a may act as an abutment member to limit a degree of entry of the heating assembly 1 into the heating zone of the apparatus. Alternatively, the threaded members themselves may be limited to control the extent of entry of the heating assembly 1 into the heating zone. Other mechanical fasteners or connectors may be used as a coupler and respective retainer as long as the heating assembly 1 can be coupled to the apparatus. The second portion 12 of the body 10 may comprise a threaded portion to act as the coupler. Additionally, or alternatively, the first portion 10 and/or third surface 10c of the second portion 12 may comprise a non-threaded portion and act as the coupler.

In this embodiment, the body 10 of the heating assembly 1 is unitary such that the first and second portions 11, 12 are integral with one another. Therefore, the first and second portions 11, 12 are fixed in position relative to each another. In this embodiment, the body 10 is generally T-shaped such that the second portion 12 has a width W₂ greater than a width W₁ of the first portion 11. That is, an exterior width or diameter of the first portion 11 is smaller than an exterior width or diameter of the second portion 12. An internal surface of the first portion 11 may be parallel to an internal surface of the second portion 12. The internal surfaces of the first and second portions 11,12 may be aligned with each other.

The body 10 comprises a cavity 20 for receiving and storing aerosolizable material which may be in the form of a rod, as shown in FIG. 2. The cavity 20 is delimited in length by a base 14 of the heating assembly 1 which defines an internal end surface of first portion 11. A shape of the cavity 20 may be complementary to a shape of an article comprising aerosolizable material. In this embodiment, the cavity 20 is circular in cross-section and cylindrical in overall shape. In other embodiments, the cavity may be non-circular in cross-section, for example the cavity may be triangular, square, rectangular, pentagonal or hexagonal. In this embodiment, the walls of the cavity 20 are closed such that aerosolizable material in the cavity 20 cannot be accessed through a wall of the cavity 20. The aerosolizable material can therefore only be accessed by an entrance through which the aerosolizable material is inserted into the cavity 20. In other embodiments, the entrance may be through a side wall rather than an end of the cavity 20. In such an example, the article comprising aerosolizable material may be inserted in a direction radial to the longitudinal axis A-A.

As shown in FIG. 1, a portion of the body 10 is open. The open portion provides access to the cavity 20 from outside of the heating assembly 1. In some examples, the body 10 is openable for insertion of the aerosolizable material into the cavity 20. For example, the cavity 20 of the body 10 may be closed by a removable or openable cap or lid. An open end 40 of the body 10 is shown in FIG. 1 that is communicable with the cavity 20. The open end 40 is an aperture through which aerosolizable material is insertable. The open end 40 is provided at a downstream end of the heating assembly 1 through which the aerosolizable material is first inserted in an upstream direction towards an upstream end opposite the downstream end. In use, at least one component of volatized aerosolized material is configured to flow away from the heating assembly 1 in a direction from the upstream end to the downstream end. Therefore, the aerosolizable material enters the cavity 20 via the open end 40. The open end 40 is defined by the second portion 12 in this embodiment.

The heating assembly 1 comprises a heating element 30. The heating element 30 may be a susceptor that is capable of being inductively heated. The heating element 30 is configured to be in thermal proximity to aerosolizable material when the aerosolizable material is inserted into the cavity 20 of the heating assembly 1. In contrast, the body 10 may be formed of a material that is not capable of being inductively heated. The body 10 may therefore act as an electrical insulator. In other embodiments, the heating element 30 may not be limited to being inductively heated. The heating element 30 may therefore be heatable by electrical resistance. The heating assembly 1 may therefore comprise electrical contacts for electrical connection with the apparatus for electrically activating the heating element 30 by passing a flow of electrical energy through the heating element 30.

The heating assembly 1 comprising the heating element 30 may be provided as a product that is discarded once used. That is, the heating element 30 may be fixed to the body 10 and not readily removable from the body 10 by a user. Alternatively, the heating element 30 may be removable from the body 10 of the heating assembly 1 and discarded when used. Therefore, the heating element 30 could be replaced with another heating element 30 when an article comprising aerosolizable material of a different type, such as a different flavor, is for insertion into the cavity 20 of the heating assembly 1. This helps to avoid cross contamination of different flavors.

When provided as a removeable item, the heating element 30 may be combinable with the heating assembly 1 to form a consumable item or an article for use with a non-combustible aerosol provision device. The heating element 30 may therefore be mounted to the body 10 of the heating assembly 1. Due to an intimate contact between the heating element 30 and a consumable item (such as an article comprising aerosolizable material), depositions of aerosol or heated components of the consumable item may collect on the heating element 30. Therefore, to improve hygiene, the heating element 30 may be disposed of and replaced with another heating element 30. A need for replacement may be determined by detecting information about a use of the apparatus as discussed in relation to FIG. 4. For example, a user may be alerted that the heating element 30 should be replaced after a predetermined number of sessions, for example at least 20 sessions. In some embodiments, the alert comprises a visual and/or audible indicator. Each session may be the time between activation and deactivation of the heating element 30 during which the user draws on an article to inhale the volatized components produced by the aerosolizable material. The number of sessions to replace the heating element 30 may be after to 40 sessions, for example.

The heating element 30 is elongate in this embodiment. A length of the heating element is therefore greater than a width of the heating element 30 perpendicular to a longitudinal axis A-A of the heating assembly 1. The heating element 30 extends from a base 14 of the body 10 into the cavity 20 of the heating assembly 1. The heating member comprises a main body 31 and a tapered portion 32. The tapered portion 32 is located at a tip of the main body 31. The tapered portion 32 is for penetration into the aerosolizable material. In some embodiments, the tapered portion 32 is tapered. The tapering may be towards a pointed end. Therefore, the heating element 30 shown in this embodiment is a male member such as a rod, blade or pin and configurable to penetrate an article comprising aerosolizable material when the article is received in the cavity 20 of the heating assembly 1. In this embodiment, the male member is configured to extend along the central axis A-A of the heating zone 110. However, in other embodiments, the male member may be offset from the central axis A-A. In either case, the male member is configured to automatically penetrate an article 70 comprising aerosolizable material when the article 70 is pressed onto the male member. When inserted into the cavity 20 of the heating assembly 1, the consumable is brought into contact and closely mates with the heating element 30.

In some embodiments, the heating element 30 may be tubular. The tubular heating element 30 may be insertable within the cavity 20 of the body 10. The tubular heating element may have a longitudinal axis that is parallel to the longitudinal axis A-A of the heating apparatus 1. The longitudinal axis of the heating element 30 may be coaxial with the longitudinal axis A-A of the heating apparatus 1. The tubular heating element 30 may at least partially define a wall of the cavity 20 into which an article comprising aerosolizable material is inserted. An example of this is shown in FIG. 5 and discussed below.

Referring to FIG. 2, an article 2 comprising aerosolizable material 2a in the form of a rod is shown. The article 2 may comprises a cover around the aerosolizable material 2a. The cover encircles the aerosolizable material 2a and helps to protect the aerosolizable material 2a from damage during transport and use of the article 2. The cover may comprise an adhesive (not shown) that adheres overlapped free ends of the wrapper to each other. The adhesive helps prevent the overlapped free ends of the wrapper from separating. In other embodiments, the adhesive and/or the cover may be omitted. In still other embodiments, the article may take a different form to any of those discussed above. The article 2 may comprise at least one filter (not shown). The article 2 comprises a downstream end and an upstream end, wherein the upstream end is insertable into the cavity 20 of the heating assembly 1 before the downstream end. The article 2 is configured such that a user draws a volatized component(s) of the aerosolizable material through the downstream end of the article 2.

The article 2 is insertable into the cavity 20 of the heating assembly 1 in a direction of the longitudinal axis A-A. In this embodiment, the insertion direction of the article 2 is the same as the insertion direction of the heating assembly 1 into an apparatus for heating the heating element 30 of the heating assembly 1. The article 2 is therefore inserted into the heating assembly 1 in an upstream direction. Equally, the heating assembly 1 is inserted into the apparatus in an upstream direction. The article 2 comprises a mouth end and a distal end. The distal end is an upstream end and the mouth end is a downstream end. The distal end of the article 2a is first inserted into the cavity 20 via the open end 40. The heating assembly 1 therefore comprises a downstream end (for example, a distal end) and an upstream end (for example, a proximal end). When fully inserted into the cavity 20, the article 2 abuts the downstream end but protrudes away from the proximal end.

An insertion force F1 is required to overcome the resistance of the heating assembly 1 to move the article 2. The insertion force F1 may be substantially constant or may varying with degree of insertion of the article 2. As the article 2 is continued to be inserted into the cavity 20, an end of the article 2 is pierced by the tapered portion 32 of the heating element 30. When fully inserted into the heating assembly 1, the article 2 is configured to protrude from the heating assembly 1. The heating assembly 1 has a length Lo that is smaller than a length of the article 2, which causes the protrusion. Given that the heating assembly 1 is removable from the apparatus, the article 2 may be inserted before or after coupling of the heating assembly 1 with the apparatus. Equally, the article 2 may be removed from the heating assembly 1 before or after decoupling of the heating assembly 1 with the apparatus. The coupler of the heating assembly 1 may resist movement of the heating assembly 1 from the retainer of the apparatus when the article 2 is withdrawn from the heating assembly 1. A connection force of the coupler and retainer may therefore be larger than a force to remove the article 2 from the heating assembly 1.

Referring to FIG. 3, there is shown a schematic cross-sectional side view of an example of a system 2000 according to an embodiment. The system 2000 comprises an apparatus 200 and a heating assembly 1 as shown in FIGS. 1 and 2 insertable into the apparatus. The article 2 comprising the aerosolizable material 2a, as discussed in FIG. 2, is further shown. The heating assembly 1 comprises the heating element 30 for use in heating aerosolizable material to volatilize at least one component of the aerosolizable material, as discussed in relation to FIGS. 1 and 2. The apparatus 200 comprises a magnetic field generator 212 for generating a varying magnetic field in use. The heating element 30 is formed from heating material that is heatable by penetration with the varying magnetic field. The magnetic field generator 212 comprises an electrical power source 213 and a device 216 for passing a varying electrical current, such as an alternating current, through a coil 214.

The apparatus 200 comprises a housing 210 defining a heating zone 211. The heating zone 211 is a chamber into which the heating assembly 1 is insertable. The chamber of the apparatus 200 is therefore a receiving portion. The chamber may comprise a surface that is shaped complementarily to a mating surface of the heating assembly 1.

As shown in FIG. 3, the article 2 is first inserted into the heating assembly 1 before the heating assembly 1 and article 2 are inserted as one into the heating zone 211 of the apparatus 200. However, the heating assembly 1 may be first inserted into the heating zone 211 of the apparatus 200 before the article 2 is inserted into the cavity 20 of the heating assembly 1. The combined heating assembly 1 and article 2 are inserted in a direction X which corresponds to a longitudinal dimension of the apparatus. Once inserted, the heating assembly 1 may be restrained by the apparatus 200 so that the heating assembly 1 is immoveable relative to the apparatus 200 in a direction Y, which is a direction perpendicular to the direction X.

The heating assembly 1 is shown with coupling regions, for example a first surface 10a, second surface 10b and a third surface 10c. Each coupling region may be referred to as a coupler. Although a single coupler 10a, 10b, 10c may be needed to engage with a respective retainer 200a, 200b, 200c of the apparatus, a plurality of couplers may be provided. The coupler 10a, 10b, 10c may be suitable for restraining movement, e.g. longitudinal movement, of the heating assembly 1 relative to the apparatus 200 when the heating assembly 1 is installed in the apparatus 200. The coupler 10a, 10b, 10c and/or retainer 200a, 200b, 200c therefore act as a blocking member to block a movement of the heating assembly 1 and retain the heating assembly 1 in the apparatus 200 relative to at least one direction of movement, e.g. movement in the direction X and/or direction Y. Such directional movement may be axial movement which is movement in an axial direction of the heating assembly 1, for example along the longitudinal axis A-A, shown in FIG. 1 (corresponding to direction X). The coupler 10a, 10b, 10c and/or retainer 200a, 200b, 200c may resist translational movement of the heating assembly 1 (corresponding to direction Y).

Alternatively, or additionally, each coupler 10a, 10b, 10c and/or each respective retainer 200a, 200b, 200c may resist rotation of the heating assembly 1 relative to the apparatus 200 about the longitudinal axis A-A.

The coupler 10a, 10b, 10c and/or retainer 200a, 200b, 200c may be an abutment member for abutting at least one surface of the respective apparatus 200 or heating assembly 1. The coupler 10a, 10b, 10c and/or retainer 200a, 200b, 200c may limit the extent of movement of the heating assembly 1.

The coupler 10a, 10b, 10c may be blockable by a corresponding abutment member or portion of the apparatus 200 to prevent movement of the heating assembly 1 or heating element 30 in the apparatus 200, particularly when an article containing aerosolizable material is removed from the heating assembly 1. Interaction between the coupler 10a, 10b, 10c and respective retainer 200a, 200b, 200c may be used to hold the heating assembly 1 in a specific location in the apparatus 200 as opposed to relying on restraining movement by a push fit relationship between the body 10 of the heating assembly 1 and the apparatus 200. Therefore, an engagement force F2 may be required to couple the heating assembly 1 with the apparatus 200. The engagement force F2 may be greater than the insertion force F1 discussed in relation to FIG. 2.

A push fit relationship, in this instance, is when a first member is insertable into a second member using an insertion force. The insertion force is force exertable by a user's fingers to overcome frictional resistance between the first and second members. Said frictional resistance holds the first and second members together under friction as one combination. Therefore, separation of the first and second members is achieved by exerting a finger force similar to the insertion force. In a push fit relationship, the first and second members are not free to move relative to each other but are also not permanently fixed in position relative to each other.

The coupler 10a, 10b, 10c and respective retainer 200a, 200b, 200c may prevent free movement of the heating assembly 1 without being fixed in position. The coupler 10a, 10b, 10c and respective retainer 200a, 200b, 200c therefore facilitate improved retention of the heating assembly 1 in an apparatus 200, such as the examples described in FIG. 4. Close positioning of the heating assembly 1 with an article comprising aerosolizable material provides improved heat transfer to the article.

Referring to FIG. 4 there is shown a cross-sectional side view of an example of a system 2000 according to an embodiment. Features in FIG. 4 with the same reference numeral as FIGS. 1 to 3 are the same.

The system 2000 comprises apparatus 200 and a heating assembly 1 insertable into the apparatus, wherein the heating assembly 1 comprises a heating element 30 for use in heating aerosolizable material to volatilize at least one component of the aerosolizable material. The apparatus 200 comprises a magnetic field generator 212 for generating a varying magnetic field in use. The heating element 30 is formed from heating material that is heatable by penetration with the varying magnetic field.

More specifically, the apparatus 200 of this embodiment comprises a housing 210. A mouthpiece (not shown) may be connected to the housing 210 and/or the heating assembly 1. The mouthpiece may be made of any suitable material, such as a plastics material, cardboard, cellulose acetate, paper, metal, glass, ceramic, or rubber. The mouthpiece may define a channel therethrough. The mouthpiece may be locatable relative to the housing 210 so as to cover an opening into a heating zone 211 or a cavity 20 of the heating assembly 1 when the heating assembly 1 is inserted into the heating zone 211. When the mouthpiece is so located relative to the housing 210, the channel of the mouthpiece is in fluid communication with the heating zone 211. In use, the channel acts as a passageway for permitting volatilized material to pass from aerosolizable material of an article inserted in the heating zone 211 to an exterior of the apparatus 200. the mouthpiece of the apparatus 200 may be releasably engageable with the housing 210 so as to connect the mouthpiece to the housing 210. In other embodiments, the mouthpiece and the housing 210 may be permanently connected, such as through a hinge or flexible member. In some embodiments, such as embodiments in which the article itself comprises a mouthpiece, the mouthpiece of the apparatus 200 may be omitted.

The apparatus 200 may define an air inlet (not shown) that fluidly connects the heating zone 211 with the exterior of the apparatus 200. Such an air inlet may be defined by the housing 210 and/or by an optional mouthpiece. A user may be able to inhale the volatilized component(s) of the aerosolizable material by drawing the volatilized component(s) through the channel of the optional mouthpiece. As the volatilized component(s) are removed from an article, air may be drawn into the heating zone 211 via the air inlet of the apparatus 200.

In the embodiment of FIG. 4, no mouthpiece is present. An article comprising aerosolizable material (also not shown) may be provided with a mouth end through which a user draws volatilized component(s) of the aerosolizable material. The mouth end may act as a mouthpiece. The cavity 20 of the heating assembly is therefore open until the article is inserted into the cavity 20 to close an open end 40 of the heating assembly 1.

In this embodiment, the housing 210 of the apparatus 200 receives the heating assembly 1 comprising the heating element 30. An inner dimension of the heating zone 211 of the apparatus 200, for example an inner diameter, is therefore greater than the first width W₁ of the body 2 of the heating assembly 1. In this embodiment, a wall of the cavity 20, which is an internal surface of the cavity 20, restricts the heating zone 211 and engages with a portion of an article comprising aerosolizable material. The portion of the article is an upstream portion. The walls of the cavity 20 mechanically mate with the article in order to co-operate with and receive the article. In this embodiment, the heating zone 211 is elongate, and is sized and shaped to accommodate the whole of a first portion 11 of a body 10 of the heating assembly 1. In other embodiments, the heating zone 211 may be dimensioned to receive only a portion of the first portion 11 of the body 10.

The heating assembly 1 comprising the heating element 30 is receivable within an accommodating part of the body 210 of the apparatus 200. The heating element 30 is shown to partially extend within a portion of an accommodating part of the body 210, such as an upstream portion of the accommodating part. The heating assembly 1 comprises an abutment which determines an extent of entry of the heating assembly 1 within the heating zone 211. A wall of the second portion 12 of the body 10 of the heating assembly may act as the abutment to abut a respective wall of the housing 210 of the apparatus 200. The wall is an exterior wall. The wall may be an upstream wall of the second portion 12 of the body 10 and/or may be an upstream wall of the first portion 11 of the body 10. Alternatively, full activation of an engagement mechanism, such as a screw thread, may determine an extent of entry of the heating assembly 1 within the heating zone 211. The abutment blocks movement of the heating assembly 1 by contact between the apparatus 200 and heating assembly 1. When the heating assembly 1 is installed in the apparatus 200, the abutment may restrain movement of the heating assembly 1 relative to the apparatus 200 by contact with the abutment. The heating assembly 1 is removable from the apparatus 200 to access the heating zone 211 and clean or inspect the heating zone 211, for example.

In this embodiment, the magnetic field generator 212 comprises an electrical power source 213, a coil 214, a device 216 for passing a varying electrical current, such as an alternating current, through the coil 214, a controller 217, and a user interface 218 for user-operation of the controller 217. The apparatus 200 of this embodiment further comprises a temperature sensor 219 for sensing a temperature of the heating zone 211.

In this embodiment, the apparatus 200 further comprises a sensor 215 to detect information about a use of the apparatus 200 when the apparatus 200 is coupled to the heating assembly 1. The information may be stored in a memory 222 of the apparatus. The memory 222 is a data storage device. The sensor 215 is to further perform an action when the information meets a predetermined criterion. In some embodiments, the sensor provides an indication when the information meets a predetermined criterion. The predetermined criterion may be a total power on time. For example, the information detected by the sensor 215 may be an elapsed time. A total power on time therefore corresponds to a detected time elapsed from the apparatus 200 being turned on. The apparatus 200 may be considered turned on when the heating element 30 is first activated. Alternatively, or additionally, the sensor 215 may detect information about a number of sessions of use of the apparatus. A single session may comprise a predetermined number of draws on an article by a user. Alternatively, a single session may comprise a predetermined time from when the user first draws on an article or when the heating element 30 is first activated.

The controller 217 is configured to control the heating device 216 based on the information. In some embodiments, the information may be analyzed by an analyzer 220 of the apparatus 200. The analyzer 220 receives information from at least one sensor 215, 219 and the information is sent to the controller to determine how to control the heating device 216 based on the information analyzed by the analyzer 220. For example, the heating device 216 may be configured to measure a number of sessions, which may be a number of activations of the power on button or a puff sensor, or may be configured to measure a total power used or power on time. Once a threshold is reached, the heating device 216 may indicate to a user that the heating element 30 needs changing and/or the heating device 216 may not allow the heating element 30 to be heatable.

The electrical power source 213 of this embodiment is a rechargeable battery. In other embodiments, the electrical power source 213 may be other than a rechargeable battery, such as a non-rechargeable battery, a capacitor, a battery-capacitor hybrid, or a connection to a mains electricity supply.

The coil 214 may take any suitable form. In this embodiment, the coil 214 is a helical coil of electrically-conductive material, such as copper. In some embodiments, the magnetic field generator 212 may comprise a magnetically permeable core around which the coil 214 is wound. Such a magnetically permeable core concentrates the magnetic flux produced by the coil 214 in use and makes a more powerful magnetic field. The magnetically permeable core may be made of iron, for example. In some embodiments, the magnetically permeable core may extend only partially along the length of the coil 214, so as to concentrate the magnetic flux only in certain regions. In some embodiments, the coil 214 may be a flat coil. That is, the coil 214 may be a two-dimensional spiral. In this embodiment, the coil 214 encircles the heating zone 211. The coil 214 extends along a longitudinal axis that is substantially aligned with a longitudinal axis of the heating zone 211. The aligned axes are coincident. In a variation to this embodiment, the aligned axes may be parallel or oblique to each other. In other embodiments, the coil 214 may be other than helical. For example, the coil 214 may be spiral. In some embodiments, the magnetic field generator 212 comprises a plurality of coils 214 for generating respective magnetic fields for penetrating respective portions of the heating element 30.

When the heating assembly 1 is coupled with the apparatus 200, a length Li of the heating assembly 1 protrudes from the cavity 20. The protrusion may be comprised by at least a portion of the second portion 12 of the body 10 of the heating assembly 1, as shown in FIG. 4. The protrusion provides a portion that can be gripped by a user to decouple the heating assembly 1 from the apparatus 2 and remove the heating assembly 1. That is, a portion of the heating assembly 1 protrudes from within the heating zone 211 so as to be grippable by a user to withdraw the heating assembly 1 from the heating zone 211. The portion may configured to be gripped by a user's fingers and may not require tools to remove the heating assembly 1. The portion may be rotated or moved linearly relative to the apparatus 200 to withdraw the heating assembly 1 from the apparatus 200.

Referring to FIG. 5 there is shown a schematic perspective view of an example of a system 2000 according to an embodiment. The system 2000 comprises apparatus 200 and a heating assembly 1 insertable into the apparatus wherein the heating assembly 1 comprises a heating element 30a for use in heating aerosolizable material to volatilize at least one component of the aerosolizable material. Features in FIG. 5 with the same reference numeral as FIG. 4 are the same. The difference between FIGS. 4 and 5 is that the heating element 30 in FIG. 4 is elongate and in the form of a blade, whereas, in FIG. 5, the heating element 30a is tubular.

The heating element 30a shown in FIG. 5 is hollow. The heating element 30a may be formed from a sheet. The heating element 30a may be a single piece. The sheet may have a constant thickness. The heating element 30a may have a constant cross-sectional shape. For example, the heating element 30a may be substantially circular, square or rectangular in cross-section along a length of the heating element 30a. A length of the heating element 30a may be greater than a width of the heating element 30a perpendicular to the length. In other embodiments, the length and width may be substantially equal. In yet more embodiments, the heating element 30a may have a length smaller than a width.

The heating element 30a shown in FIG. 5 is generally cylindrical with a substantially circular cross section. In other embodiments, the heating element 30a may have an oval or elliptical cross section or may be other than cylindrical. In some embodiments, the heating element 30a may have a polygonal, quadrilateral, rectangular, square, triangular, star-shaped, or irregular cross section, for example. In this embodiment, the heating element 30a is a tube. The heating element 30a comprises a chamber which is a hollow inner region of the tube. The chamber may correspond to a heating zone when the heating element 30a is arranged in an apparatus 200. The chamber is configured for receiving the aerosolizable material. The heating element 30a may comprise an extruded member formed by an extrusion process. The extruded member may be tubular so that a cross section of the body is endless with no joins.

The heating element 30a in FIG. 5 is open at both a first end and a second end that is opposite the first end. The first end therefore comprises a first opening and the second end comprises a second opening. The first and second openings may be axially aligned on the longitudinal axis A-A shown in FIG. 1. The first and second openings may be parallel to one another. Aerosolizable material may be insertable into the cavity 20 through an opening 40.

Therefore, the opening 40 is the initial point of passage of aerosolizable material into the cavity 20. Longitudinal wall(s) of the heating element 30a extend between the first end and the second end of the heating element 30a. Alternatively, the heating element 30a may have a single open end.

A thickness of the heating element 30a may be less than 100 μm. The thickness may be between 10 μm and 40 μm. The thickness may be between 20 μm and 30 μm. The thickness may be about 25 μm.

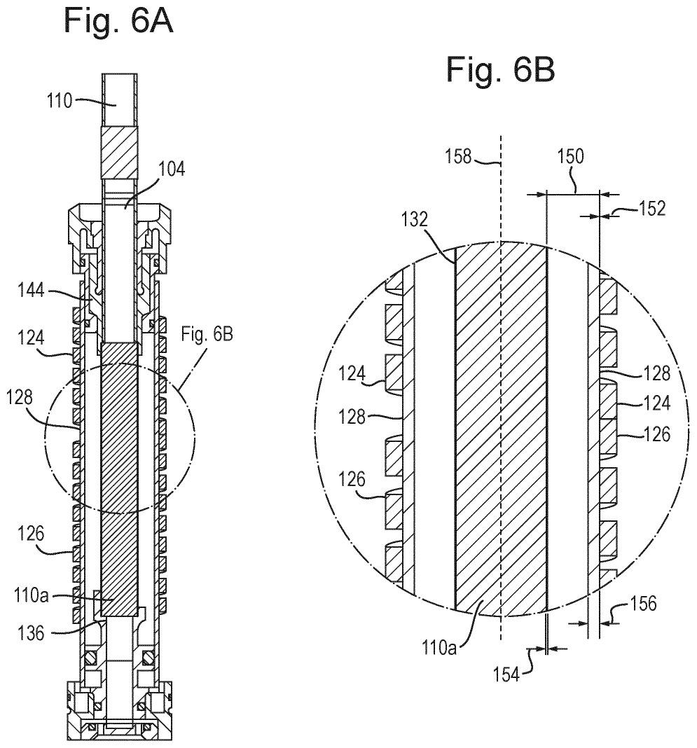

FIG. 6A depicts a cross section of a portion of an aerosol generating device according to an embodiment.

A first inductor coil 124 is shown which is configured to generate a first varying magnetic field for heating a first section of a susceptor 132. Also shown is a second inductor coil 126 configured to generate a second varying magnetic field for heating a second section of the susceptor 132. In this example, the first inductor coil 124 is adjacent to the second inductor coil 126 in a direction along the longitudinal axis 134 of the device (that is, the first and second inductor coils 124, 126 to not overlap). The susceptor arrangement 132 may comprise a single susceptor, or two or more separate susceptors, with at least one of the susceptors comprising a ferritic element. Ends 130 of the first and second inductor coils 124, 126 can be connected to a PCB (not shown), which can be configured to pass a varying (e.g. alternating) current from a power source e.g. battery (not shown) to the inductor coils 124, 126 such that the varying magnetic field is produced. Other examples are contemplated where there is only one inductor coil present.

In some examples, the ferritic element of the one or more susceptors 132 may also comprise a ceramic material. The terrific element can be formed by mixing iron (III) oxide (Fe₂O₃) with one or more additional metallic elements such as barium, manganese, nickel or zinc. The terrific element may be electrically nonconductive and act as an electrical insulator, which may prevent any surge of current from the inductors 124, 126 reaching or arcing to any other sections or portions of the aerosol-generating device. In other examples, the ferritic element may also itself be magnetizable.

In the example shown, the heating assembly is an inductive heating assembly and comprises various components to heat the aerosol-generating material of a consumable 110 via an inductive and conductive heating process, the consumable 110 comprising a non-magnetic metallic component such as an aluminum element disposed within (not shown).

According to embodiments the consumable 110 or aerosol generating article may be manufactured by providing an outer wrapper, introducing aerosol generating material onto the outer wrapper and then introducing the non-magnetic metallic component. The outer wrapper may then be secured around both the aerosol generating material and the non-magnetic metallic component.

According to an alternative embodiment aerosol generating material may be provided within an outer wrapper which is secured around the aerosol generating material and then the non-magnetic metallic component may be inserted into the aerosol generating material.

The aluminum element disposed with the consumable 110 improves heating via conduction and will be discussed in more detail below. Induction heating is a process of heating an electrically conducting object (such as a susceptor) by electromagnetic induction. An induction heating assembly may comprise an inductive element, for example, one or more inductor coils, and a device for passing a varying electric current, such as an alternating electric current, through the inductive element. The varying electric current in the inductive element produces a varying magnetic field. The varying magnetic field penetrates a susceptor suitably positioned with respect to the inductive element, and generates eddy currents inside the susceptor. The susceptor has electrical resistance to the eddy currents, and hence the flow of the eddy currents against this resistance causes the susceptor to be heated by Joule heating. In cases where the susceptor comprises ferromagnetic material such as iron, nickel or cobalt, heat may also be generated by magnetic hysteresis losses in the susceptor, i.e. by the varying orientation of magnetic dipoles in the magnetic material as a result of their alignment with the varying magnetic field. In inductive heating, as compared to heating by conduction for example, heat is generated inside the susceptor, allowing for rapid heating. Further, there need not be any physical contact between the inductive heater and the susceptor, allowing for enhanced freedom in construction and application.

As discussed above, the induction heating assembly of the aerosol-generating devices as shown in FIG. 6A comprises a susceptor arrangement 132 (herein referred to as “a susceptor”), a first inductor coil 124 and a second inductor coil 126. The first and second inductor coils 124, 126 are made from an electrically conducting material. In this example, the first and second inductor coils 124, 126 are made from LITZ (RTM) wire/cable which is wound in a helical fashion to provide helical inductor coils 124, 126. LITZ (RTM) wire comprises a plurality of individual wires which are individually insulated and are twisted together to form a single wire. LITZ (RTM) wires are designed to reduce the skin effect losses in a conductor. In this example, the first and second inductor coils 124, 126 are made from copper LITZ (RTM) wire which has a rectangular cross section. In other examples the LITZ (RTM) wire can have other shape cross sections, such as circular.

FIG. 6B depicts a close-up of a region of FIG. 6A. FIGS. 6A and 6B show a consumable 110 received within the susceptor 132, where the consumable 110 is dimensioned so that the outer surface of the consumable 110 abuts the inner surface of the susceptor 132. This ensures that the heating is most efficient. The consumable 110 of this example comprises aerosol generating material 110a. The aerosol generating material 110a is positioned within the susceptor 132. The consumable 110 of this example further comprises an aluminum strip (not shown) disposed within, to improve heating characteristics. The consumable 110 may also comprise other components such as a filter, wrapping materials and/or a cooling structure.

FIG. 6B shows that the outer surface of the susceptor 132 is spaced apart from the inner surface of the inductor coils 124, 126 by a distance 150, measured in a direction perpendicular to a longitudinal axis 158 of the susceptor 132. In one particular example, the distance 150 is about 3 mm to 4 mm, about 3 mm to 3.5 mm, or about 3.25 mm.

FIG. 6B further shows that the outer surface of an insulating member 128 is spaced apart from the inner surface of the inductor coils 124, 126 by a distance 152, measured in a direction perpendicular to a longitudinal axis 158 of the susceptor 132. In one particular example, the distance 152 is about 0.05 mm. In another example, the distance 152 is substantially 0 mm, such that the inductor coils 124, 126 abut and touch the insulating member 128.

In use, the first inductor coil 124 is configured to generate a first varying magnetic field for heating a first section of the susceptor 132 and the second inductor coil 126 is configured to generate a second varying magnetic field for heating a second section of the susceptor 132. In this example, the first inductor coil 124 is adjacent to the second inductor coil 126 in a direction along the longitudinal axis 134 of the device 100 (that is, the first and second inductor coils 124, 126 to not overlap). The susceptor arrangement 132 may comprise a single susceptor, or two or more separate susceptors, wherein at least one of the susceptors comprises a ferritic element. Ends 130 of the first and second inductor coils 124, 126 can be connected to a PCB (not shown), which can configured to pass a varying (e.g. alternating) current from a power source e.g. battery (not shown) to the inductor coils 124, 126 such that the varying magnetic field is produced. As the section or sections of the one or more susceptors 132 heat up due to the induction process, heat is also transferred to the aluminum element of the consumable 110 via conduction heating. It will be apparent therefore, that the inclusion of the aluminum strip achieves improved and more rapid heating of the consumable 110, which can result in a higher amount of aerosol-generated material to be produced during a specific time duration.

When the consumable 110 is inserted into the aerosol-generating device, it may be inserted such that, at least a portion of non-magnetic metallic component (i.e. an aluminum element) is located in close proximity to at least a portion of the ferritic element of the one or more susceptors 132. This will improve the conductive heating process from the susceptor to the aluminum element, thus improving the overall heating of the consumable 110 e.g. by inductive heating of the susceptor and conductive heating of the aluminum element. The aluminum element may be located such that it is located less than 10 mm, 9 mm, 8 mm, 7 mm, 6 mm, 5 mm, 4 mm, 3 mm, 2 mm or 1 mm from at least a portion of the ferritic element of the one or more susceptors 132.

It will be appreciated that the first and second inductor coils 124, 126, in some examples, may have at least one characteristic different from each other. For example, the first inductor coil 124 may have at least one characteristic different from the second inductor coil 126. More specifically, in one example, the first inductor coil 124 may have a different value of inductance than the second inductor coil 126. In other examples, the first and second inductor coils 124, 126 are of different lengths such that the first inductor coil 124 is wound over a smaller section of the susceptor 132 than the second inductor coil 126. Thus, the first inductor coil 124 may comprise a different number of turns than the second inductor coil 126 (assuming that the spacing between individual turns is substantially the same). In yet another example, the first inductor coil 124 may be made from a different material to the second inductor coil 126. In some examples, the first and second inductor coils 124, 126 may be substantially identical.

In this example, the first inductor coil 124 and the second inductor coil 126 are wound in opposite directions. This is can be useful when the inductor coils are active at different times. For example, initially, the first inductor coil 124 may be operating to heat a first section of the consumable 110, and at a later time, the second inductor coil 126 may be operating to heat a second section of the consumable 110. Winding the coils in opposite directions helps reduce the current induced in the inactive coil when used in conjunction with a particular type of control circuit. In other examples, the first inductor coil 124 is a right-hand helix and the second inductor coil 126 is a left-hand helix. However, in another example, the inductor coils 124, 126 may be wound in the same direction, or the first inductor coil 124 may be a left-hand helix and the second inductor coil 126 may be a right-hand helix.

The susceptor 132 of this example is hollow and therefore defines a receptacle within which aerosol generating material is received. For example, the consumable 110 can be inserted into the susceptor 132. In this example the susceptor 120 is tubular, with a circular cross section.

In one example, the susceptor 132 has a wall thickness 154 of about 0.025 mm to 1 mm, or about 0.05 mm.

In one example, the susceptor 132 has a length of about 40 mm to 60 mm, about 40 mm to 45 mm, or about 44.5 mm.

In one example, the insulating member 128 has a wall thickness 156 of about 0.25 mm to 2 mm, 0.25 mm to 1 mm, or about 0.5 mm.

In some embodiments, the susceptor 132 may comprise one or more materials selected from the group consisting of: an electrically-conductive material, a magnetic material, and a magnetic electrically-conductive material. In some embodiments, the susceptor 132 may comprise a metal or a metal alloy. In some embodiments, the susceptor 132 may comprise one or more materials selected from the group consisting of: aluminum, gold, iron, nickel, cobalt, conductive carbon, graphite, steel, plain-carbon steel, mild steel, stainless steel, ferritic stainless steel, molybdenum, silicon carbide, copper, and bronze. Other heating material(s) may be used in other embodiments.

In some embodiments, the sheet comprising heating material is a free from holes or discontinuities. In some embodiments, the sheet comprising heating material comprises a foil, such as a metal or metal alloy foil, e.g. aluminum foil. However, in some embodiments, the sheet comprising heating material may have holes or discontinuities. For example, in some embodiments, the sheet comprising heating material may comprise a mesh, a perforated sheet, or a perforated foil, such as a metal or metal alloy perforated foil, e.g. perforated aluminum foil.

In some embodiments, such as those in which the heating material comprises iron, such as steel (e.g. mild steel or stainless steel) or aluminum, the sheet comprising heating material may be coated to help avoid corrosion or oxidation of the heating material in use. Such coating may, for example, comprise nickel plating, gold plating, or a coating of a ceramic or an inert polymer. In some embodiments, the sheet comprising heating material comprises or consists of nickel plated aluminum foil.

The heating material may have a skin depth, which is an exterior zone within which most of an induced electrical current and/or induced reorientation of magnetic dipoles occurs. By providing that the heating material has a relatively small thickness, a greater proportion of the heating material may be heatable by a given varying magnetic field, as compared to heating material having a depth or thickness that is relatively large as compared to the other dimensions of the heating material. Thus, a more efficient use of material is achieved and, in turn, costs are reduced.

In some embodiments, the aerosolizable material comprises tobacco. However, in other embodiments, the aerosolizable material may consist of tobacco, may consist substantially entirely of tobacco, may comprise tobacco and aerosolizable material other than tobacco, may comprise aerosolizable material other than tobacco, or may be free from tobacco. In some embodiments, the aerosolizable material may comprise a vapor or aerosol forming agent or a humectant, such as glycerol, propylene glycol, triacetin, or diethylene glycol.

In some embodiments, the aerosolizable material is non-liquid aerosolizable material, and the apparatus is for heating non-liquid aerosolizable material to volatilize at least one component of the aerosolizable material.

According to an embodiment an aerosol generating device is disclosed comprising one or more inductor coils and one or more susceptors. At least one of the susceptors comprises one or more ferritic elements. The one or more ferritic elements may comprise a ceramic material. The one or more ferritic elements may be formed by mixing iron (III) oxide (Fe₂O₃) with one or more additional metallic elements to form a mixture and then heating the mixture to form a ceramic. The one or more additional metallic elements may be selected from the group comprising: (i) barium; (ii) manganese; (iii) nickel; and (iv) zinc.

The one or more terrific elements may be electrically non-conductive. The one or more ferritic elements may comprise an electrical insulator. The more ferritic elements may be either: (i) magnetizable; (ii) ferromagnetic; or (iii) ferrimagnetic.

The one or more inductor coils may be arranged to generate a varying magnetic field and wherein the one or more susceptors may be arranged to become heated by the varying magnetic field. The one or more susceptors may be arranged and adapted to heat not burn aerosolizable material provided in an article for use with a non-combustible aerosol provision device. According to an embodiment the one or more susceptors may be arranged and adapted to generate aerosol from aerosolizable material provided in an article for use with a non-combustible aerosol provision device. The aerosol generating device may comprise a heat not burn aerosol generating device.

An aerosol generating system is disclosed comprising an aerosol generating device as described above and an article for use with a non-combustible aerosol provision device.

The article for use with a non-combustible aerosol provision device may include one or more aluminum elements. According to an embodiment the article for use with a non-combustible aerosol provision device may be inserted into the aerosol generating device so that at least a portion of one of the aluminum elements is located in close proximity to at least a portion of one of the terrific elements. According to an embodiment the article for use with a non-combustible aerosol provision device may be inserted into the aerosol generating device so that at least a portion of one of the aluminum elements is located less than 10 mm, 9 mm, 8 mm, 7 mm, 6 mm, 5 mm, 4 mm, 3 mm, 2 mm or 1 mm from at least a portion of one of the ferritic elements.

According to an embodiment the article for use with a non-combustible aerosol provision device may comprise aerosolizable material. The aerosolizable material may be provided: (i) as a solid; (ii) as a liquid; (iii) in the form of a gel; (iv) in the form of a thin film substrate; (v) in the form of a thin film substrate having multiple regions; or (vi) in the form of a thin film substrate having multiple regions, wherein at least two of the regions comprise aerosolizable material having different compositions.

A method of generating an aerosol is also disclosed comprising providing an aerosol generating device comprising one or more inductor coils and one or more susceptors, wherein at least one of the susceptors comprises one or more ferritic elements and inserting an article for use with a non-combustible aerosol provision device into the aerosol generating device.

The article for use with a non-combustible aerosol provision device may include one or more aluminum elements. The article for use with a non-combustible aerosol provision device may be inserted into the aerosol generating device so that at least a portion of one of the aluminum elements is located in close proximity to at least a portion of one of the ferritic elements.

An aerosol generating system is also disclosed comprising an aerosol generating device comprising one or more terrific susceptors and an article for use with a non-combustible aerosol provision device having one or more non-magnetic metallic elements.

The one or more non-magnetic metallic elements may comprise aluminum.

The one or more non-magnetic metallic elements may be arranged so as to be positioned in thermal contact with the one or more ferritic susceptors.

The article for use with a non-combustible aerosol provision device may be arranged to be inserted into the aerosol generating device so that at least a portion of one of the non-magnetic metallic elements is located less than 10 mm, 9 mm, 8 mm, 7 mm, 6 mm, 5 mm, 4 mm, 3 mm, 2 mm or 1 mm from at least a portion of one of the ferritic susceptors.

An aerosol generating system is also disclosed comprising an aerosol generating device comprising one or more inductor coils and an article for use with a non-combustible aerosol provision device located, in use, within the aerosol generating device. In addition, one or more removable susceptors may be provided which located, in use, within the aerosol generating device.

According to an embodiment the one or more removable susceptors may comprise one or more ferritic elements. The one or more terrific elements may comprise a ceramic material. The one or more ferritic elements may be formed by mixing iron (III) oxide (Fe₂O₃) with one or more additional metallic elements to form a mixture and then heating the mixture to form a ceramic. The one or more additional metallic elements may be selected from the group comprising: (i) barium; (ii) manganese; (iii) nickel; and (iv) zinc. The ferritic element may be electrically non-conductive. The ferritic element may comprise an electrical insulator.

The ferritic element may be either: (i) magnetizable; (ii) ferromagnetic; or (iii) ferrimagnetic.

The one or more inductor coils may be arranged to generate a varying magnetic field and wherein the one or more susceptors may be arranged to become heated by the varying magnetic field.

The one or more susceptors may be arranged and adapted to heat not burn aerosolizable material provided in the article for use with a non-combustible aerosol provision device The one or more susceptors may be arranged and adapted to generate aerosol from aerosolizable material provided in the article for use with a non-combustible aerosol provision device

The article for use with a non-combustible aerosol provision device may include one or more aluminum elements.

According to an embodiment the article for use with a non-combustible aerosol provision device may be inserted into the aerosol generating device so that at least a portion of one of the aluminum elements is located in close proximity to at least a portion of one of the ferritic elements.

The article for use with a non-combustible aerosol provision device may be inserted into the aerosol generating device so that at least a portion of one of the aluminum elements is located less than 10 mm, 9 mm, 8 mm, 7 mm, 6 mm, 5 mm, 4 mm, 3 mm, 2 mm or 1 mm from at least a portion of one of the terrific elements.

The article for use with a non-combustible aerosol provision device may comprise aerosolizable material and may be provided: (i) as a solid; (ii) as a liquid; (iii) in the form of a gel; (iv) in the form of a thin film substrate; (v) in the form of a thin film substrate having multiple regions; or (vi) in the form of a thin film substrate having multiple regions, wherein at least two of the regions comprise aerosolizable material having different compositions.

An aerosol generating device is disclosed comprising one or more inductor coils, wherein the device is arranged and adapted: (i) to receive an article for use with a non-combustible aerosol provision device which is located, in use, within the aerosol generating device; and (ii) to receive one or more removable susceptors which are located, in use, within the aerosol generating device.

A method of generating an aerosol is disclosed comprising providing an aerosol generating device comprising one or more inductor coils, locating an article for use with a non-combustible aerosol provision device within the aerosol generating device and locating one or more removable susceptors within the aerosol generating device.

An aerosol generating system is disclosed comprising an aerosol generating device and an article for use with a non-combustible aerosol provision device located, in use, within the aerosol generating device, wherein the article for use with a non-combustible aerosol provision device may comprise one or more inductor coils and/or one or more susceptors.

The one or more susceptors may comprise one or more ferritic elements. The one or more ferritic elements may comprise a ceramic material. The one or more ferritic elements may be formed by mixing iron (III) oxide (Fe₂O₃) with one or more additional metallic elements to form a mixture and then heating the mixture to form a ceramic. The one or more additional metallic elements may be selected from the group comprising: (i) barium; (ii) manganese; (iii) nickel; and (iv) zinc.

The one or more terrific elements may be electrically non-conductive. The one or more ferritic elements may be an electrical insulator.

The one or more terrific elements may be either: (i) magnetizable; (ii) ferromagnetic; or (iii) ferrimagnetic. According to an embodiment the one or more inductor coils may be arranged to generate a varying magnetic field and wherein the one or more susceptors may be arranged to become heated by the varying magnetic field.

The one or more susceptors may be arranged and adapted to heat not burn aerosolizable material provided in the article for use with a non-combustible aerosol provision device. The one or more susceptors may be arranged and adapted to generate aerosol from aerosolizable material provided in the article for use with a non-combustible aerosol provision device

The article for use with a non-combustible aerosol provision device may include one or more aluminum elements.

The article for use with a non-combustible aerosol provision device may be inserted into the aerosol generating device so that at least a portion of one of the aluminum elements is located in close proximity to at least a portion of one of the ferritic elements.

The article for use with a non-combustible aerosol provision device may be inserted into the aerosol generating device so that at least a portion of one of the aluminum elements is located less than 10 mm, 9 mm, 8 mm, 7 mm, 6 mm, 5 mm, 4 mm, 3 mm, 2 mm or 1 mm from at least a portion of one of the terrific elements.

The article for use with a non-combustible aerosol provision device may comprise aerosolizable material. The aerosolizable material may be provided: (i) as a solid; (ii) as a liquid; (iii) in the form of a gel; (iv) in the form of a thin film substrate; (v) in the form of a thin film substrate having multiple regions; or (vi) in the form of a thin film substrate having multiple regions, wherein at least two of the regions comprise aerosolizable material having different compositions.

A method of generating an aerosol is disclosed comprising providing an aerosol generating device and inserting an article for use with a non-combustible aerosol provision device into the aerosol generating device wherein the article for use with a non-combustible aerosol provision device may comprise one or more inductor coils and/or one or more susceptors.

The article for use with a non-combustible aerosol provision device may include one or more aluminum elements.

The article for use with a non-combustible aerosol provision device may be inserted into the aerosol generating device so that at least a portion of one of the aluminum elements is located in close proximity to at least a portion of one of the ferritic elements.

The article for use with a non-combustible aerosol provision device may be inserted into the aerosol generating device so that at least a portion of one of the aluminum elements is located less than 10 mm, 9 mm, 8 mm, 7 mm, 6 mm, 5 mm, 4 mm, 3 mm, 2 mm or 1 mm from at least a portion of one of the terrific elements.

A method of fabricating an aerosol generating device is also disclosed comprising forming one or more inductor coils and one or more susceptors within the device, wherein at least one of the susceptors may comprise one or more ferritic elements.

A method of fabricating a susceptor is also disclosed comprising forming one or more removable susceptors which are located, in use, within an aerosol generating device and which may be readily removed from the aerosol generating device.

A method of fabricating an article for use with a non-combustible aerosol provision device is also disclosed comprising forming an article for use with a non-combustible aerosol provision device which is located, in use, within an aerosol generating device, wherein the article for use with a non-combustible aerosol provision device may comprise one or more inductor coils and/or one or more susceptors.

In some embodiments, the article 2 is a consumable article or an article for use with a non-combustible aerosol provision device. Once all, or substantially all, of the volatilizable component(s) of the aerosolizable material 2a in the article 2 has/have been spent, the user may remove the article 2 from the cavity 20 of the heating assembly 1 and dispose of the article 2. The user may subsequently re-use the apparatus 200 with another of the articles 2. However, in other respective embodiments, the article 2 may be non-consumable relative to the heating assembly. That is, the heating assembly 1 and the article 2 may be disposed of together once the volatilizable component(s) of the aerosolizable material 2a has/have been spent.

In some embodiments, the article 2 is sold, supplied or otherwise provided separately from the apparatus 200 with which the article 2 is usable. However, in some embodiments, the apparatus 200 and one or more of the articles 2 may be provided together as a system, such as a kit or an assembly, possibly with additional components, such as cleaning utensils.

The aerosol generating device, aerosol generating system and the inductor coil according to various embodiments find particular utility when generating aerosol from a substantially flat consumable. The substantially flat consumable may be provided in either an array or a circular format. Other arrangements are also contemplated.

In some embodiments e.g. wherein the substantially flat consumable is provided in the form of an array, multiple heating regions may be provided. For example, according to an embodiment one heating region may be provided per portion, pixel or portion of the consumable. In other embodiments, the substantially flat consumable may be rotated such that a segment of the consumable is heated by a similar shaped heater. According to this embodiment a single heating region may be provided.

In particular, the inductor coil according to various embodiments may be provided as part of a non-combustible aerosol provision device which is arranged to heat-not-burn a consumable as part of a non-combustible aerosol provision system. In particular, the consumable may comprise a plurality of discrete portions of aerosol-generating material, The consumable may comprise a support on which the aerosol-generating material is provided. The support functions as a support on which the aerosol-generating material forms, easing manufacture. The support may provide tensile strength to the aerosol-generating material, easing handling. In some cases, the plurality of discrete portions of aerosol-generating material are deposited on such a support. In some cases, the plurality of discrete portions of amorphous material is deposited on such a support. In some cases, the discrete portions of aerosol-generating material are deposited on such a support such that each discrete portion may be heated and aerosolized separately.

Suitably, the discrete portions of aerosol-generating material are provided on the support such that each discrete portion may be heated and aerosolized separately. It has been found that a consumable having such a conformation allows a consistent aerosol to be delivered to the user with each puff.

In some cases, the support may be formed from materials selected from metal foil, paper, carbon paper, greaseproof paper, ceramic, carbon allotropes such as graphite and graphene, plastic, cardboard, wood or combinations thereof. In some cases, the support may comprise or consist of a tobacco material, such as a sheet of reconstituted tobacco. In some cases, the support may be formed from materials selected from metal foil, paper, cardboard, wood or combinations thereof. In some cases, the support itself be a laminate structure comprising layers of materials selected from the preceding lists. In some cases, the support may also function as a flavorant carrier. For example, the support may be impregnated with a flavorant or with tobacco extract. In some cases, the support may be non-magnetic. In some cases, the support may be magnetic.

This functionality may be used to fasten the support to the assembly in use, or may be used to generate particular shapes of aerosol generating material. In some cases, the aerosol-generating material may comprise one or more magnets which can be used to fasten the material to an induction heater in use.

In some cases, the support may be substantially or wholly impermeable to gas and/or aerosol. This prevents aerosol or gas passage through the support layer, thereby controlling the flow and ensuring it is delivered to the user. This can also be used to prevent condensation or other deposition of the gas/aerosol in use on, for example, the surface of a heater provided in an aerosol generating assembly. Thus, consumption efficiency and hygiene can be improved in some cases.

In some cases, the surface of the support that abuts the aerosol-generating material may be porous. For example, in one case, the support comprises paper. It has been found that a porous support such as paper is particularly suitable for the present disclosure; the porous (e.g. paper) layer abuts the aerosol-generating material and forms a strong bond. The aerosol-generating material is formed by drying a gel and, without being limited by theory, it is thought that the slurry from which the gel is formed partially impregnates the porous support (e.g. paper) so that when the gel sets and forms cross-links, the support is partially bound into the gel. This provides a strong binding between the gel and the support (and between the dried gel and the support).

In one particular case, the support may be a paper-backed foil; the paper layer abuts the aerosol-generating material and the properties discussed in the previous paragraphs are afforded by this abutment. The foil backing is substantially impermeable, providing control of the aerosol flow path. A metal foil backing may also serve to conduct heat to the aerosol-generating material.

In another case, the foil layer of the paper-backed foil abuts the aerosol-generating material. The foil is substantially impermeable, thereby preventing water provided in the aerosol-generating material to be absorbed into the paper which could weaken its structural integrity.

In some cases, the support is formed from or comprises metal foil, such as aluminum foil. A metallic support may allow for better conduction of thermal energy to the aerosol generating material (aerosolizable material). Additionally, or alternatively, a metal foil may function as a susceptor in an induction heating system. In particular embodiments, the support comprises a metal foil layer and a support layer, such as cardboard. In these embodiments, the metal foil layer may have a thickness of less than 20 μm, such as from about 1 μm to about 10 μm, suitably about Slim.

In some cases, the support may have a thickness of between about 0.010 mm and about 2.0 mm, suitably from about 0.015 mm, 0.02 mm, 0.05 mm or 0.1 mm to about 1.5 mm, 1.0 mm, or 0.5 mm.

In order to address various issues and advance the art, the entirety of this disclosure shows by way of illustration and example various embodiments in which the claimed invention may be practised and which provide for superior heating elements for use with apparatus for heating aerosolizable material, methods of forming a heating element for use with apparatus for heating aerosolizable material to volatilize at least one component of the aerosolizable material, and systems comprising apparatus for heating aerosolizable material to volatilize at least one component of the aerosolizable material and a heating element heatable by such apparatus. The advantages and features of the disclosure are of a representative sample of embodiments only, and are not exhaustive and/or exclusive. They are presented only to assist in understanding and teach the claimed and otherwise disclosed features. It is to be understood that advantages, embodiments, examples, functions, features, structures and/or other aspects of the disclosure are not to be considered limitations on the disclosure as defined by the claims or limitations on equivalents to the claims, and that other embodiments may be utilized and modifications may be made without departing from the scope and/or spirit of the disclosure. Various embodiments may suitably comprise, consist of, or consist in essence of, various combinations of the disclosed elements, components, features, parts, steps, means, etc. The disclosure may include other inventions not presently claimed, but which may be claimed in future.

1. An aerosol generating system comprising:
an aerosol generating device having one or more inductor coils and one or more susceptors,
wherein, in use, an article for use with a non-combustible aerosol provision device comprising a non-magnetic metallic component is positioned in proximity to one or more of the one or more susceptors.

2. The aerosol generating system as claimed in claim 1, wherein the one or more susceptors comprise one or more ferritic elements comprising a ceramic material.

3. The aerosol generating system as claimed in claim 2, wherein the one or more ferritic elements are formed by mixing iron (III) oxide (Fe₂O₃) with one or more additional metallic elements to form a mixture and then heating the mixture to form a ceramic.

4. The aerosol generating system as claimed in claim 3, wherein the one or more additional metallic elements is selected from the group comprising: barium; manganese; nickel; and zinc.

5. The aerosol generating system as claimed in claim 2, wherein the one or more ferritic elements are electrically non-conductive.

6. The aerosol generating system as claimed in claim 2, wherein the one or more ferritic elements are an electrical insulator.

7. The aerosol generating system as claimed in claim 2, wherein the one or more ferritic elements are either: magnetisable; ferromagnetic; or ferrimagnetic.

8. The aerosol generating system as claimed in claim 1, wherein the one or more inductor coils are arranged to generate a varying magnetic field and wherein the one or more susceptors are arranged to become heated by the varying magnetic field.

9. The aerosol generating system as claimed in claim 8, wherein the one or more susceptors are arranged and adapted to heat not burn aerosolizable material provided in an article for use with a non-combustible aerosol provision device.

10. The aerosol generating system as claimed in claim 8, wherein the one or more susceptors are arranged and adapted to generate aerosol from aerosolizable material provided in an article for use with a non-combustible aerosol provision device.

11. The aerosol generating system as claimed in claim 1, wherein the aerosol generating device comprises a heat not burn aerosol generating device.

12. The aerosol generating system as claimed in claim 1, wherein the aerosol generating device comprises a non-combustible aerosol provision device.

13. The aerosol generating system as claimed in claim 1, in combination with an article for use with a non-combustible aerosol provision device.

14. The aerosol generating system as claimed in claim 13, wherein the article for use with a non-combustible aerosol provision device includes one or more aluminium elements.

15. The aerosol generating system as claimed in claim 14, wherein, in use, the article for use with a non-combustible aerosol provision device is inserted into the aerosol generating device so that at least a portion of one of the aluminium elements is located in close proximity to at least a portion of one of the ferritic elements.

16. The aerosol generating system as claimed in claim 15, wherein, in use, the article for use with a non-combustible aerosol provision device is inserted into the aerosol generating device so that at least a portion of one of the aluminium elements is located less than 10 mm, 9 mm, 8 mm, 7 mm, 6 mm, 5 mm, 4 mm, 3 mm, 2 mm or 1 mm from at least a portion of one of the ferritic elements.

17. The aerosol generating system as claimed in claim 13, wherein the article for use with a non-combustible aerosol provision device comprises aerosolizable material.

18. The aerosol generating system as claimed in claim 17, wherein the aerosolizable material is provided: (i) as a solid; (ii) as a liquid; (iii) in the form of a gel; (iv) in the form of a thin film substrate; (v) in the form of a thin film substrate having multiple regions; or (vi) in the form of a thin film substrate having multiple regions, wherein at least two of the regions comprise aerosolizable material having different compositions.

19. A method of generating an aerosol comprising:
providing an aerosol generating device having one or more inductor coils and one or more susceptors; and
inserting an article for use with a non-combustible aerosol provision device comprising a non-magnetic metallic component in proximity to one or more of the susceptors.

20. A method as claimed in claim 19, wherein the article for use with a non-combustible aerosol provision device includes one or more aluminium elements.

21-71. (canceled)
